(19) United States
(12) Patent Application Publication
(10) Pub. No.: US 2021/0031952 A1
(43) Pub. Date: Feb. 4, 2021

(54) PAYLOAD CARRIER ASSEMBLY

(71) Applicant: RUAG SCHWEIZ AG, Zürich (CH)

(72) Inventors: Joseph Patrick MORAN, Winkel (CH); Michael THUSWALDNER, Linköping (SE)

(21) Appl. No.: 16/964,135

(22) PCT Filed: Nov. 14, 2018
(86) PCT No.: PCT/EP2018/081218

§ 371 Date: Jul. 22, 2020

(30) Foreign Application Priority Data
Jan. 22, 2018 (CH) 63/18

(51) Int. Cl. B64G 1/64; B64G 1/00

(52) U.S. Cl. CPC B64G 1/641; B64G 1/002; B64G 1/645

(57) ABSTRACT

A payload carrier assembly comprises a payload fairing (1) for protecting at least one payload (3) mounted on at least one payload carrier (20) of a launcher (2), comprising at least one separable fairing part (10, 11) that can be arranged on top of the launcher (2) around the payload (3) to be launched, wherein the payload carrier assembly further comprises at least one first transfer element (4), which is in contact with the at least one fairing part (10, 11) and which, in the assembled state, can be in contact with at least the at least one payload (3) and can transfer forces, applied to the at least one payload (3), to the at least one fairing part (10, 11) and vice versa.

### TECHNICAL FIELD OF THE INVENTION

The current invention relates to payload carrier assemblies for payload mounted on a launcher.

### DESCRIPTION OF THE RELATED ART

Known embodiments of payload carriers are heavy in design, to withstand the thereon applied forces during the launch, especially during the time, the launcher is still within earth's atmosphere. A heavier payload carrier reduces the weight of the payload or requires a launcher with increased mass to orbit capability for the same payload mass.

### SUMMARY OF THE INVENTION

It is the purpose of the current invention to provide a payload carrier assembly where the above-mentioned disadvantages can be avoided.

This task is solved by a payload carrier assembly with the features of claim 1. Further embodiments of the payload carrier assembly are defined by the features of further claims.

A payload carrier assembly according to the invention comprises a payload fairing for protecting at least one payload mounted on at least one payload carrier of a launcher, at least one separable fairing part that can be arranged on top of the launcher around the payload to be launched, wherein the fairing part is separable from the launcher at a predefined moment after the launch. The payload fairing can be in one piece or can comprise several pieces. The payload carrier assembly further comprises at least one first transfer element, which is in contact with the at least one fairing part and which, in the assembled state, can be in contact with at least the at least one payload and can transfer forces, applied to the at least one fairing part, to the at least one payload and vice versa. Thus, imparting stiffness to the entire payload carrier assembly. With such a design, the imparted stiffness results in an increased payload capability. Additionally, some of the forces applied to one part of the payload can be transferred to another part of the payload and/or to the payload fairing or where there are several payloads, some of the forces can be transferred from one of the payloads to another of the payload by means of the transfer element, making the entire assembly stiffer. Thus, the total forces on the payload resulting from the launch induced accelerations, particularly during the initial phase of the launch, is distributed more evenly within the entire assembly. As a result, the applied forces are not only introduced at a few specific locations that must withstand the total load, but are in an ideal case evenly distributed within the entire assembly. This design allows to build the payload in a lighter manner. As a result, the weight reduction can be compensated by increasing the weight of the payload, i.e. by adding additional components or heavier components. Further transfer elements can be installed between one location of the at least one fairing part and another location of the at least one fairing part or between one fairing part and another fairing part. There can be two, three, four, five, six or more fairing parts. The fairing parts can be segments of a dome-shaped payload fairing. Alternatively, the payload fairing can have the shape of a cylinder with a cone at its upper side or upper end, i.e. its nose.

In an embodiment, the payload carrier assembly further comprises at least one second transfer element, which is in contact with the at least one fairing part and which, in the assembled state, can be in contact with at least one payload carrier and can transfer forces, applied to the at least one payload carrier to the at least one fairing part, and vice versa. Thus, imparting stiffness to the payload carrier and the entire payload carrier assembly. With such a design, the imparted stiffness results in an increased payload capability. Additionally, some of the forces applied to the payload carrier can be transferred to the payload fairing or some of the forces can be transferred from one part of the payload carrier to another part of the payload carrier and/or to the fairing. Thus, the applied forces are more evenly distributed and therefore, the payload carrier must withstand less of the thereon applied forces in specific locations and therefore, the design of the payload carrier can be made lighter. As a result, the weight reduction can be compensated by increasing the weight of the payload.

In an embodiment, the transfer elements are connected to at least one element selected from the group comprising the at least one payload, the at least one payload carrier and the at least one fairing part, wherein the connection can be stiff or pivoting. The payload carrier assembly further comprises at least one separation device, which can separate the connection between the at least one fairing part and the at least one payload. Several types of separation devices, for example pyro-nuts, bolt-cutters or ejection by means of compressed springs can be used.

In an embodiment, the payload carrier assembly further comprises at least one separation device, which can separate the connection between the at least one fairing part and the at least one payload or between the at least one fairing part and the at least one payload carrier.

In an embodiment, the payload carrier assembly further comprises at least one separation device, which can separate the connection between two payloads.

In an embodiment, the at least one separation device is arranged on the payload fairing-side and/or on the payload-side of the at least one transfer element. Alternatively, several separation devices can be arranged along the at least one transfer element.

In an embodiment, the payload carrier assembly comprises a plurality of first transfer elements that are arranged over the height and/or over the circumference of the at least one fairing part.

In an embodiment, the payload carrier assembly comprises a plurality of second transfer elements that are arranged over the height and/or over the circumference of the at least one fairing part. The first and/or second transfer elements can be distributed evenly over the height and/or over the circumference of the at least one fairing part.

In an embodiment, a plurality of first transfer elements are in contact with the at least one fairing part at a common location.

In an embodiment, a plurality of second transfer elements are in contact with the at least one fairing part at a common location.

In an embodiment, a plurality of first transfer elements are adapted to be in contact with the at least one payload at a common location.

In an embodiment, a plurality of second transfer elements are adapted to be in contact with the at least one payload carrier at a common location. Alternatively, the plurality of first and/or second transfer elements can be connected to the at least one payload and/or to the at least one payload carrier and/or to the at least one fairing part at a common connection or with a common connecting element.

In an embodiment, the at least one first transfer element and/or the at least one second transfer element is rod-shaped, disk-shaped or funnel-shaped or has the shape of a radiused bulkhead. A disk, a funnel or a bulkhead can comprise two or more segments, i.e. three, four, five, six or more segments, which can be separated from each other by means of additional separation devices. These separation devices can be activated simultaneously or before the separation devices that are allocated at the free ends of the transfer elements.

The features of the above-mentioned embodiments of the payload carrier assembly can be used in any combination, unless they contradict each other.

A method for using a payload carrier assembly according to the invention comprises the steps of:
arranging a payload on a payload carrier on a launcher;
arranging at least one payload fairing part around the payload; and
bringing into contact at least one transfer element on its one free end with the payload and/or with the payload carrier and on its other free end with at least one of the at least one payload fairing parts.

In an embodiment, the method further comprises the steps of:
providing separation devices at each transfer element and
activating the separation devices.

The activation of the separation devices can occur before, simultaneously to or after the fairing parts have been separated from the launcher and/or from each other.

### BRIEF DESCRIPTION OF THE DRAWINGS

Embodiments of the current invention are described in more detail in the following with reference to the figures. These are for illustrative purposes only and are not to be construed as limiting. It shows

FIG. 1 a schematic section view of a first embodiment of a payload carrier assembly according to the invention; and

FIG. 2 a schematic section view of a second embodiment of a payload carrier assembly according to the invention.

### DETAILED DESCRIPTION OF THE INVENTION

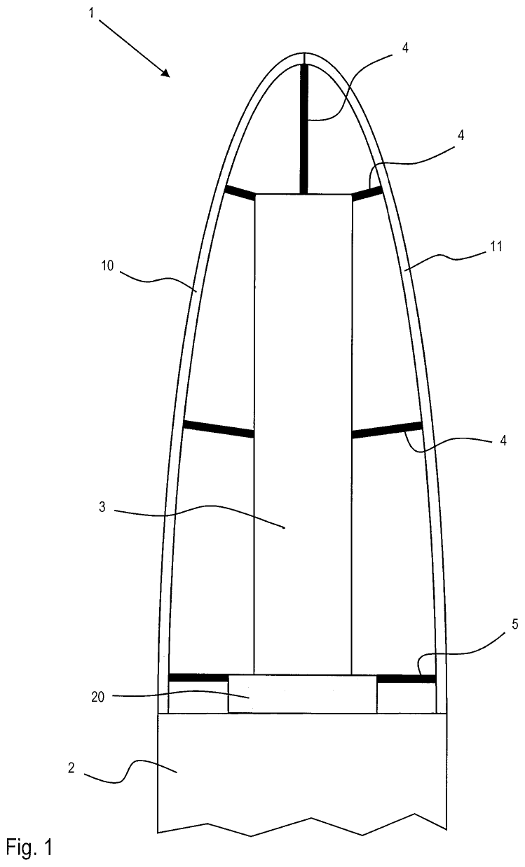

FIG. 1 shows a schematic section view of a first embodiment of a payload carrier assembly according to the invention. The payload carrier assembly comprises a payload fairing 1 that comprises a first fairing part 10 and a second fairing part 11, which can be arranged around a payload 3 that is mounted on a payload carrier 20 that is arranged on the tip of a launcher 2. The fairing parts 10, 11 are essentially dome-shaped. A single payload 3 is centrally mounted to a first payload carrier 20, that is allocated in the centre of the tip of the launcher 2. Alternatively, the payload can be mounted off centre with respect to the launcher's tip. The first payload carrier 20 is designed to be able to receive one single payload 3. First transfer elements 4 connect the fairing parts 10, 11 to the payload 3. In the case of rods, the first transfer elements 4 are arranged on essentially opposite sides with respect to the payload 3 or on top of the payload 3, opposite to the first payload carrier 20. In the case of disks, funnels or bulkheads, the first transfer elements 4 are arranged around the payload 3. A force applied to the payload 3 can be transferred to the first fairing part 10 by means of a first transfer element 4 and by means of another first transfer element 4 to the second fairing part 11. Second transfer elements 5 connect the payload carrier 20 to the fairing parts 10, 11. In case of rods, the second transfer elements 5 are arranged on essentially opposite sides with respect to the payload carrier 20 and in case of disks, funnels or bulkheads, the second transfer element 5 is arranged around the payload carrier. A force applied to the payload carrier 20 can be transferred to the first fairing part 10 by means of a second transfer element 5 and by means of another second transfer element 5 to the second fairing part 11. When the payload 3 needs to be released from the payload carrier 20, for example, typically, when the launcher 2 has left the earth's atmosphere, separation devices can be activated on at least one of the free ends of each first or second transfer element 4, 5. Thereafter or simultaneously, the fairing parts 10, 11 can be separated from each other and from the launcher 2.

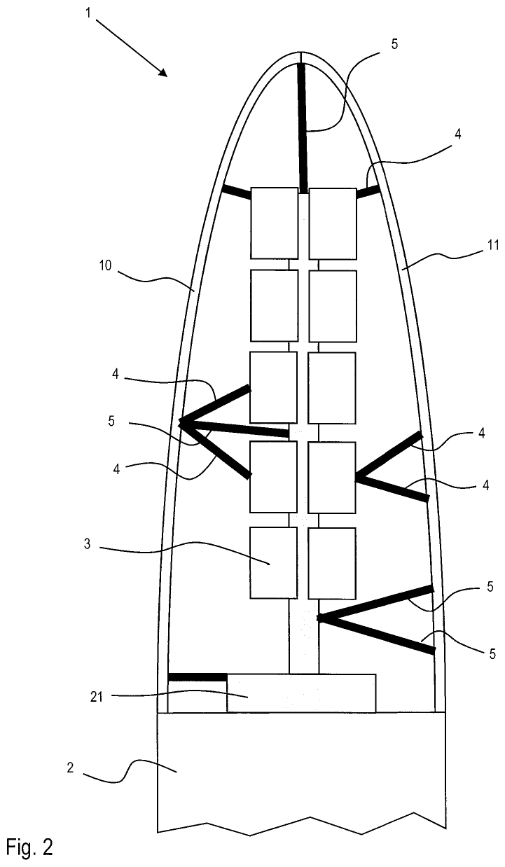

FIG. 2 shows a schematic section view of a second embodiment of a payload carrier assembly according to the invention. In contrast to the first embodiment, in the second embodiment, there is a second payload carrier 21, that has a tower-like or tree-like structure, which can receive a plurality of payloads 3. With such an arrangement, several payloads 3 can be arranged over the height and the width of the second payload carrier 21. The payload carrier 21, as well as the payloads 3 can be connected to the payload fairing parts 10, 11 by means of first and second transfer elements 4, 5. Several transfer elements 4, 5 can extend from a common connection at one fairing part 10, to several locations of the payload carrier 21 and/or to one or more payloads 3. Also, several transfer elements 4, 5 can extend from a common connection at the payload carrier 21 and/or at one of the payloads 3 to one of the fairing parts 10, 11. Like in the embodiment of FIG. 1, the first and second transfer elements 4, 5 can be arranged on opposite sides with respect to the payload 3 and/or with respect to the second payload carrier 21 or the transfer elements 4, 5 can be arranged on the payload 3 and/or on the payload carrier 21 on the opposite side of the launcher's tip. In the case of disks, funnels or bulkheads, the first and or second transfer elements 4, 5 are arranged around the payload 3 and/or around the payload carrier 21.

REFERENCE SIGNS LIST

| | | | |
|---|---|---|---|
| 1 | Payload fairing | 3 | Payload |
| 10 | first fairing part | 4 | first transfer element |
| 11 | second fairing part | 5 | second transfer element |
| 2 | Launcher | | |
| 20 | first payload carrier | | |
| 21 | second payload carrier | | |

1. A payload carrier assembly comprising:
a payload fairing (1) for protecting at least one payload (3) mounted on at least one payload carrier (20, 21) of a launcher (2),
at least one separable fairing part (10, 11) that can be arranged on top of the launcher (2) around the at least one payload (3) to be launched,
characterised in that the payload carrier assembly further comprising:
at least one first transfer element (4), which is in contact with the at least one fairing part (10, 11) and which, in the assembled state, can be in contact with at least the at least one payload (3) and can transfer forces, applied to the at least one payload (3), to the at least one fairing part (10, 11) and vice versa.

2. The payload carrier assembly according to claim 1, further comprising at least one second transfer element (5), which is in contact with the at least one fairing part (10, 11) and which, in the assembled state, can be in contact with at least one payload carrier (20, 21) and can transfer forces, applied to the payload carrier (20, 21), to the at least one fairing part (10, 11) and vice versa.

3. The payload carrier assembly according to claim 1 or 2, wherein the transfer elements (4, 5) are connected to at least one element selected from the group comprising the at least one payload (3), the at least one payload carrier (20, 21) and the at least one fairing part (10, 11), further comprising at least one separation device, which can separate the connection between the at least one fairing part (10, 11) and the at least one payload (3) and/or between the at least one fairing part (10, 11) and the at least one payload carrier (20, 21) and/or between two payloads (3).

4. The payload carrier assembly according to claim 3, wherein the at least one separation device is arranged on the payload fairing-side and/or on the payload-side of the at least one first transfer element (4).

5. The payload carrier assembly according to claim 3, wherein the at least one separation device is arranged on the payload fairing-side and/or on the payload-side of the at least one second transfer element (5).

6. The payload carrier assembly according to claim 1, comprising a plurality of first transfer elements (4) that are arranged over the height and/or over the circumference of the at least one fairing part (10, 11).

7. The payload carrier assembly according to claim 2, comprising a plurality of second transfer elements (5) that are arranged over the height and/or over the circumference of the at least one fairing part (10, 11).

8. The payload carrier assembly according to claim 1, wherein a plurality of first transfer elements (4) are in contact with the at least one fairing part (10, 11) at a common location.

9. The payload carrier assembly according to claim 2, wherein a plurality of second transfer elements (5) are in contact with the at least one fairing part (10, 11) at a common location.

10. The payload carrier assembly according to claim 1, wherein a plurality of first transfer elements (4) are adapted to be in contact with the at least one payload (3) at a common location.

11. The payload carrier assembly according to claim 2, wherein a plurality of second transfer elements (5) are adapted to be in contact with the at least one payload carrier (20, 21) at a common location.

12. The payload carrier assembly according to claim 2, wherein the at least one first transfer element (4) and/or the at least one second transfer element (5) is rod-shaped, disk-shaped or funnel-shaped or has the shape of a radiused bulkhead.

13. A method for using a payload carrier assembly according to the invention, the method comprising the steps of:
arranging a payload (3) on a payload carrier (20, 21) on a launcher (2);
arranging at least one payload fairing part (10, 11) around the payload (3); and
bringing into contact at least one transfer element (4, 5) on its one free end with the payload (3) and/or with the payload carrier (20, 21) and on its other free end with at least one of the at least one payload fairing parts (10, 11).

14. The method of claim 13, further comprising the steps of:
providing separation devices at each transfer element (4, 5); and
activating the separation devices.
